(19) United States
(12) Patent Application Publication
(10) Pub. No.: US 2010/0161088 A1
(43) Pub. Date: Jun. 24, 2010

(54) GPS Triggered, Radio Frequency Controlled Audio System

(76) Inventors: William B. Rottenberg, Durango, CO (US); Roderick Barker, Durango, CO (US)

Correspondence Address: JOHN RICHARD MERKLING, 11171 WEST EXPOSITION DRIVE, LAKEWOOD, CO, 80226-3867, US

(21) Appl. No.: 12/639,780

(22) Filed: Dec. 16, 2009

Related U.S. Application Data
(60) Provisional application No. 61/140,285, filed on Dec. 23, 2008.

(51) Int. Cl. G06F 17/00

(52) U.S. Cl. 700/94

(57) ABSTRACT

An audio information system comprising an audio player that is triggered by an RF signal. The RF signal is generated by a GPS controller that recognizes a location and sends a command to the players to play a specific track. The system consists of individual audio players and central GPS/RF transmitters. Each individual player contains all of the audio content, and the appropriate track is selected by an RF command. The GPS/RF controller contains a list of locations, and when the GPS controller is near one of the locations an RF signal is transmitted indicating which track for the audio players to play.

This application claims the benefit of U.S. Provisional Application 61/140,285, filed Dec. 23, 2008.

### FIELD OF THE INVENTION

This invention relates to the field of remote-controlled audio systems, specifically to systems providing audio presentations that are location specific, such as audio tours.

### BACKGROUND OF THE INVENTION

Audio/video tours have become common and are very popular and useful enhancements of the self-guided tour market. These systems operate by providing an audio or video player that is either manually or automatically queued as the user goes to various sites. Manually queued systems use markers to tell the user what track/video to play while automatically queued systems can use global position satellite (GPS) technology or local transmitters to trigger the player. These systems provide additional information to the user that is not possible in any other way. Individual systems can provide customized content (language or tracks focused on the user's particular interests), are not intrusive (a speaker at a site would disturb other visitors), and are timed to the individual user (a visitor would have to wait for a common display to end if it is already running), to name a few of the advantages.

Manually triggered systems require the exhibit to include a method of indicating when content is available and how the user can identify the correct track. The user then has to activate the content. This non-automaticity makes these systems seem antique with today's capabilities. Manually triggered audio players or personal digital assistants (PDA) can play a track called for at a certain location. PDA's have the added disadvantage of the higher cost of a PDA over an audio player when graphics is not desired for the specified application.

There exist audio players that have built-in GPS locators. These devices can play a track specific to a current location, but these devices are expensive, since each device includes a GPS receiver. Similarly, there are GPS enabled personal digital assistants (PDA), but these not only have the extra cost of the GPS, but the additional the cost of the PDA.

Automatic systems that use GPS technologies to trigger content require each individual unit to include a GPS receiver, increasing the cost of the individual units. These systems would be more desirable for an individual to own, since the content can be loaded for various locations and the system works anywhere for the user, but for a local attraction where the site wants to provide the content, the increased cost of the individual units is not necessary. RF triggered systems require a transmitter near each site that triggers the individual player. This can require many transmitters, and adding a location requires adding another transmitter at the location.

Video systems are desirable in situations where graphics can provide additional useful information for each site on the tour. Walking tours where the user can pause to view the video are well-suited for this application. However, in situations where the user is moving, the video would be a distraction to the user. If the video is not required, the additional capability adds unnecessary cost.

### BRIEF DESCRIPTION OF THE INVENTION

The invention herein disclosed combines various aspects of these technologies to provide a product that meets the needs of a specific segment of the audio/video tour market: the cost-sensitive moving tour where video is not necessary and automatic triggering is required. It provides an audio player that is triggered by an RF signal. The RF signal is generated by a GPS controller that recognizes a location and sends a command to the players to play a specific track. The initial market is the scenic train tour, but other similar markets exist.

The system may comprise individual audio players and central GPS/RF transmitters. Each individual player contains all of the audio content, and the appropriate track is selected by an RF command The GPS/RF controller amy contain a list of locations, and when the GPS controller is near one of the locations an RF signal is transmitted indicating which track for the audio players to play.

The system may also comprise an RF triggered audio player and a GPS enabled RF controller. Tracks on the audio player are timed and direction specific, to allow the system to start the track before reaching the desired location. The system may send transmissions to specific sections of a vehicle, such as specific cars of a train, to make the time correspond better than one transmitter could do. RF controllers automatically identify their section at the start of each trip, dynamically responding to vehicle configuration changes. Each audio player detects which section it is in so it only responds to the proper controller transmission.

Location identification can be accomplished by identifying “profiles” of controllers that are detected in each section of the vehicle. The controllers can build these profiles by broadcasting an identifying number in sequence while the controllers record which other controllers they heard. In this way, each controller builds a profile, or sequence of identifying numbers, from the identifying numbers of other controllers heard in its section. The controllers can then transmit their profiles and the players can compare the transmitted profiles with the one that they actually detect. The audio player is in the section that matches the profile the player detected when the controllers were broadcasting their number.

Controllers may identify their profile at regular intervals, to allow audio players that change sections to detect in what section they are. The controller network is self-correcting in that if a controller fails, the configuration of controllers will automatically change the profiles and the audio players will automatically change their profile in response to the change.

Controllers may also determine the direction the vehicle is traveling in by sampling an early location at the beginning of a trip. The audio players may be turned to a standby mode at the end of the trip by a location coded to do this.

The system may also include dynamic configuration of GPS location sensitivity based on the type of vehicle with which the system is used.

Another feature of the invention may include a networked method of upgrading the GPS list where one controller is updated and the update propagates throughout the network to the other controllers.

These and other features and aspects of the invention will be apparent from the following detailed description, together with the accompanying drawings.

### BRIEF DESCRIPTION OF THE DRAWINGS

FIG. 1 is a schematic representation of a transportation system, such as a tourist train, employing an automatic tour guide according to the present invention.

FIG. 2 is a schematic diagram of a program for initializing GPS/RF controllers.

FIGS. 3 through 5 are schematic diagrams of radio frequency coverage between adjacent GPS/RF controllers.

FIG. 6 is a flow chart of a program for controlling an automatic tour guide system.

FIG. 7 is a flow chart of a program for a reverse direction.

FIG. 8 is a flow chart for control of an MP3 player for use with the present invention.

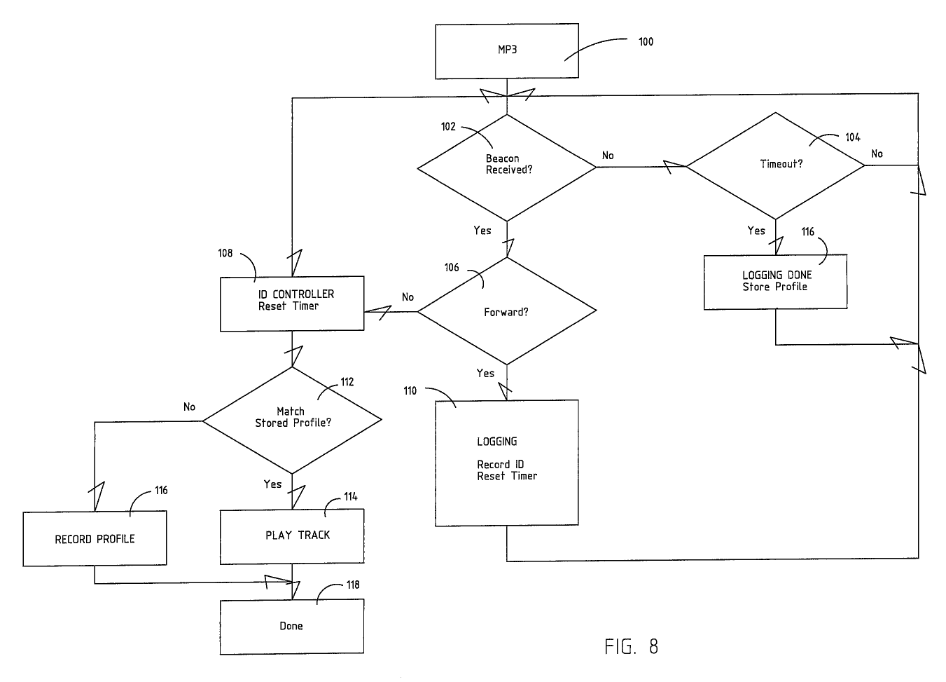

### DETAILED DESCRIPTION OF THE INVENTION

The system consists of two devices: at least one RF triggered audio player and at least one central GPS/RF controller. Preferably, a series of GPS/RF controllers communicate with a plurality of RF triggered audio players. Each audio player may be controlled by any of the GPS/RF controllers, depending on the proximity of the particular player to a particular controller.

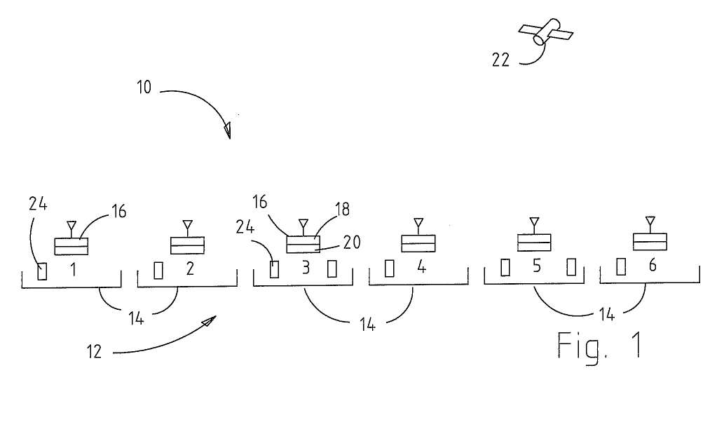

A communications system 10 is illustrated schematically in FIG. 1 in connection with a transportation system, such as a passenger or tourist train 12. The train 12 comprises a plurality of passenger cars 14, numbered sequentially 1 through 6. For purposes of this example, it is assumed that the train is moving from right to left, that is, that car number 1 is the leading car, followed by car number 2, and so on through the last car, car number 6. Each of the cars is provided with a controller 16, comprising a global positioning system (GPS) 18 and a low power radio frequency (RF) transmitter 20. The controllers 16 are relatively uniformly spaced away from each other. It is not necessary to have a controller on each car. A controller could be placed on every other car, on every third car, or such other uniform pattern, so long as overlapping signals from adjacent controllers can be produced, as explained below. The controllers 16 receive global positioning information from satellites 22, correlate that information to available tracks or themes stored on audio players 24, and broadcasts that information together with an identification of the controller.

A plurality of audio players 24 are within the transmission range of one or more controllers. Although an audio player may have a fixed location on the train 12, preferably an audio player is carried by a passenger. The passenger is free to move about a passenger car 14, or may move from one car to another, thus changing the relationship between the audio player and the audio player. The audio player, as explained below, receives identifying information from one or more of the controllers, determines which controller is closest to the audio player at a particular time, and plays or enables playing of an audio track or theme identified by the selected controller at that time.

The RF triggered audio player 24 consists of an audio player, preferably an MP3 player, but any suitable format could be used, and an RF receiver. The player can be powered by standard batteries or rechargeable batteries. The player contains all of the tracks that it will play, in this embodiment stored in an SD memory card or other memory mechanism. The player allows selection of the language and tracks or themes, from among those stored in memory. The themes can offer content that is specifically of interest to the user. In an exemplary application, a scenic train tour, themes could include information of general interest, mining history, geology, train period information, Indian history, and so on.

The GPS/RF controller has a list of locations corresponding to the content available on the audio player. The locations can be stored in a removable storage medium, such as an SD memory card, or stored in on-board memory. The list can be upgraded by replacing the SD memory card, or through a communication protocol either wired (such as USB), or wireless through the RF interface. Additionally, if the list is upgraded through a communication protocol, the controllers can act in a network where once one controller is upgraded the upgrade process propagates through the network automatically son only one controller needs to be manually upgraded. When a location is reached, based on the GPS location, the controller transmits which theme/track to play.

There are several housekeeping tasks that the system must perform to operate efficiently. The use of these techniques will become apparent later in this discussion.

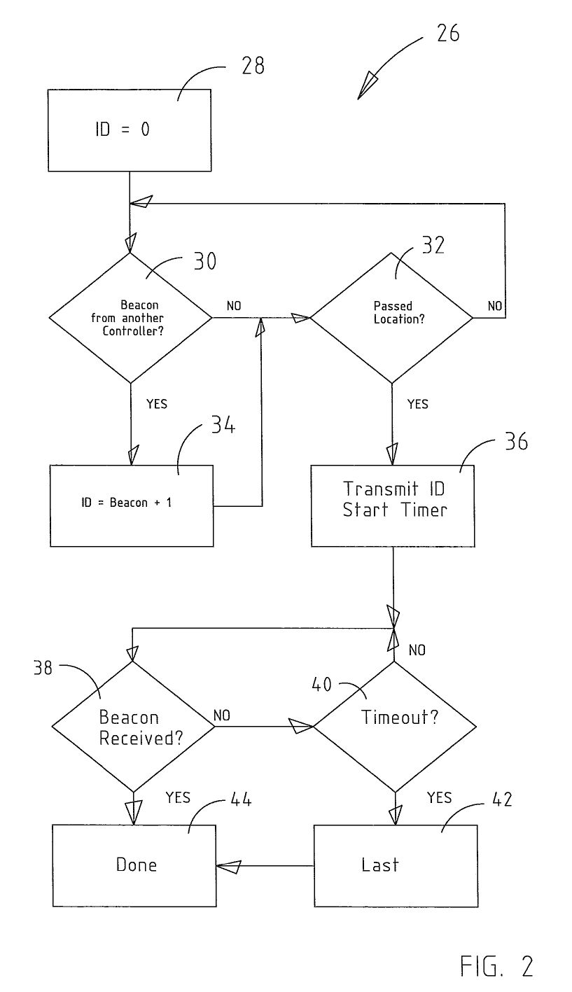

Large vehicles, such as the train 12, may require several controllers, either to cover the entire vehicle due to range limitations of the transmitters and/or for better location resolution. If there are several controllers, it would be advantageous for each transmitter to know where it is relative to the other controllers. It is most important to know where the controllers are relative to the direction of travel of the vehicle. This can most directly be accomplished by having each controller transmit its GPS location, and the other controllers build a table of the locations of all of the other controllers. This level of detail isn't necessary and would present complications. Since it is only important to know the relative location of each controller in the direction of travel of the vehicle, this can easily be accomplished by having each controller send a beacon when it passes a specific location. This algorithm 26 is shown graphically in the flowchart in FIG. 2. This first controller would claim 28 number one, and it would know this because it hadn't heard 30 any beacons before itself. It would transmit a beacon including its relative location of “one”. The next controller to cross 32 the specific location would call 34 the next sequential number, “two”. This would continue until all controllers passed the set location and learned 36 where they are in the sequence. The last section would also be identified 38 by the absence of any later beacons within a time-out period. This adaptive identification is desirable over specifying the sequence on installation because it makes installation easier, simplifies the controller user interface because it doesn't require programming control, and accounts for changes in the vehicle configuration, such as the addition or removal of train cars. The system could perform this configuration once the vehicle starts moving, as detected by the GPS position.

It is important for the players 16 to know which section of the vehicle they are in. This can be accomplished in several ways. One method can use the signal strength of the controller transmission, using the strongest signal. The player would have to remember which controller is considered local because waiting until all transmissions are received before responding would essentially make the player respond, in time, to the last transmission every time.

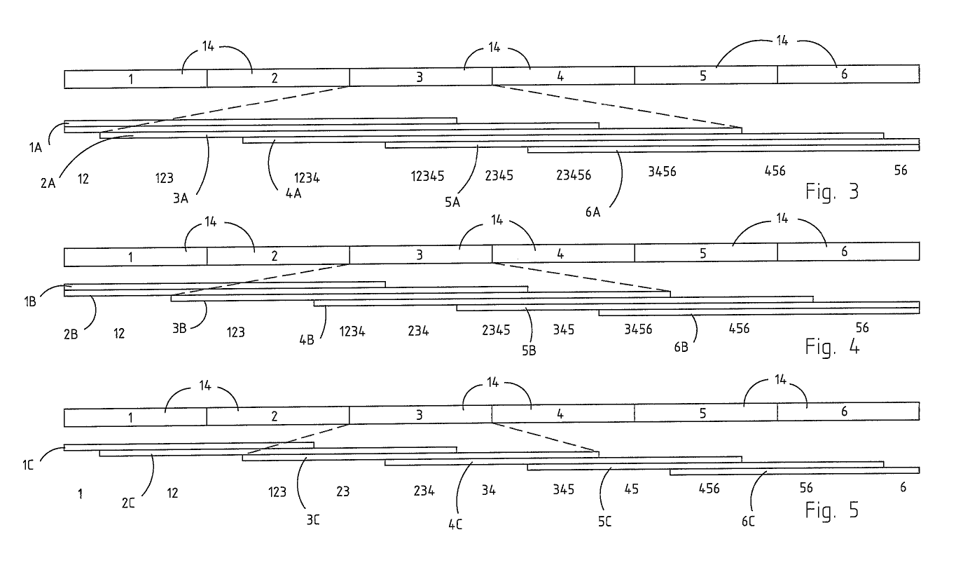

Location identification can also be accomplished by identifying profiles of controllers that are detected in each section of the vehicle. The controllers can build these profiles by broadcasting their number in sequence while the controllers record which other controllers they heard, as illustrated in FIGS. 3, 4 and 5. In this way, each controller builds a profile of other controllers heard in its section. The controllers can then transmit their profiles and the players can compare the transmitted profiles with the one that they actually detect. The audio player is in the section that matches the profile the player detected when the controllers were broadcasting their number. There will be some areas between sections that may not completely match a controller profile, but enough information will be available to identify both adjoining controllers and a decision can be made as to which section the player joins, typically the earlier section because it is generally better to be notified too early rather than too late. If the controllers regularly perform this task, players can always determine what section they are in, even as they change sections.

Various profiles are shown for different transmission powers for a nine section vehicle in FIGS. 3, 4, and 5. Profiles can be built in several ways. In one embodiment, the controller in the first section is instructed to initiate profile updates at a regular interval, and each subsequent controller has a slightly longer interval. In this way, the first controller regularly starts a profile update, but if it fails the second controller will spontaneously start a profile update after determining that the first controller failed. The profile update consists of each controller sequentially broadcasting its number, each controller triggered by the previous controller, with a timeout set so if a controller fails the subsequent ones will trigger and the update will continue. Each controller records its profile by storing all broadcasts it heard. When the broadcasts reach the last car, the last controller broadcasts its number, followed by the profile it saw. The next prior controller than broadcasts its profile until the first controller broadcasts its profile. During the first leg of this procedure, the players record the controllers they heard, building the profile that the player detects. It then matches this to the profiles transmitted during the second phase. By the end of this process, each player has matched the profile it detects to the profile for a given section, so each player knows which controller is closest to the player's location.

The size of the sections will generally be ½ the range of the transmitters, with some smaller areas near the edges of the sections. FIG. 3, for example, schematically illustrates the exemplary train 12 with six cars and six centrally located controllers. The horizontal bars 1A, 2A, 3A, 4A, 5A, and 6A represent the effective transmission ranges of the controllers in each of the respective cars. The controller in car 3, for example, broadcasts to the range of bar 3A, as shown by the dotted lines. At any given location, an audio player 24 can receive a signal from one or more of the controllers, as shown by the over lapping bars. The numbers horizontally displayed at the bottom of FIG. 3 represent the identification signals received by an audio player at that position on the train. For example, at the extreme front of the train, an audio player would receive a signal “12”, that is, a signal from controller 1 and a signal from controller 2. Near the center of car 3, an audio player would receive transmissions from controllers 1, 2, 3, 4, and 5, or an identification signal of “12345”. At the exact center of the train, signals from the controller 1 and 6 would not be heard, and the received identification signal would be “2345”. Better section resolution can be gained by decreasing the range of the transmitters, as shown, for example in FIG. 4, where the range of transmission, represented by bars 1B, 2B, 3B, 4B, 5B, and 6B, extends just beyond each adjacent car, as shown by the dotted lines extending from car 3. If the entire vehicle is smaller than ½ the range of the transmitter, only 1 section is possible. The controllers must minimally reach one controller on either side, as shown by bars 1C, 2C, 3C, 4C, 5C and 6C in FIG. 5.

It is also important for the controllers to know the direction of travel along the given route (for a generally north-south route, is the vehicle heading north from the southern starting point or heading south from the northern starting point). This can easily be accomplished by setting a location very early in the path in each direction. Once the vehicle starts moving and passes the location, the controller would know in which direction it is heading.

The simplest configuration consists of one controller for the entire vehicle. If the vehicle is small, this is acceptable, but if the vehicle is large, sections of the vehicle will reach locations significantly before others so the notifications need to be timed for each section.

Timing can be made more accurate if several controllers are used, one for each section of the vehicle. The controller would have to include its section in the transmission so that only players in its section would respond to the transmission, since there will be overlap of sections and players in adjoining sections would receive transmissions from several controllers. The system is self-correcting in that if a controller fails in one section, the profiles will automatically change at the next profile update and the players in the section of the failed controller will be picked up by adjoining controllers.

The audio players can have a backup mode in case their controller fails before a profile update is performed, or in case noise prevents a transmission from being received. If a player detects transmissions from the controllers within its profile, but never detects a transmission from its section controller, it can use one of the other transmissions, specifically a section near its section, to trigger the appropriate track. If a section was intentionally excluded from a transmission (for example if the site is not visible from that section), a transmission from the controller will indicate this case to the players in the section to over-ride this backup mechanism.

The audio players are battery powered, and maximizing battery life is crucial. Several techniques are utilized to do this. The audio player section of the circuit is disabled when no track is played. Once a track is started, the receiver is disabled until the track is completed. Then the player is disabled and the receiver is re-enabled. The audio player is also disabled at the end of the trip by a special location code that causes the players to go into a standby mode. The players are re-enabled manually, since using an RF trigger to re-enable the device would require the RF receiver to remain on, using power.

The location matching algorithm resolution is configured with the stored tracks, so that different vehicles can use different margins of error around a specific location, depending on how precisely they follow a route. A train could use a very small margin since it tracks very precisely a route, while a bus can vary more as it changes lanes, and a boat would require a very large margin since it can stray far from the GPS target locations.

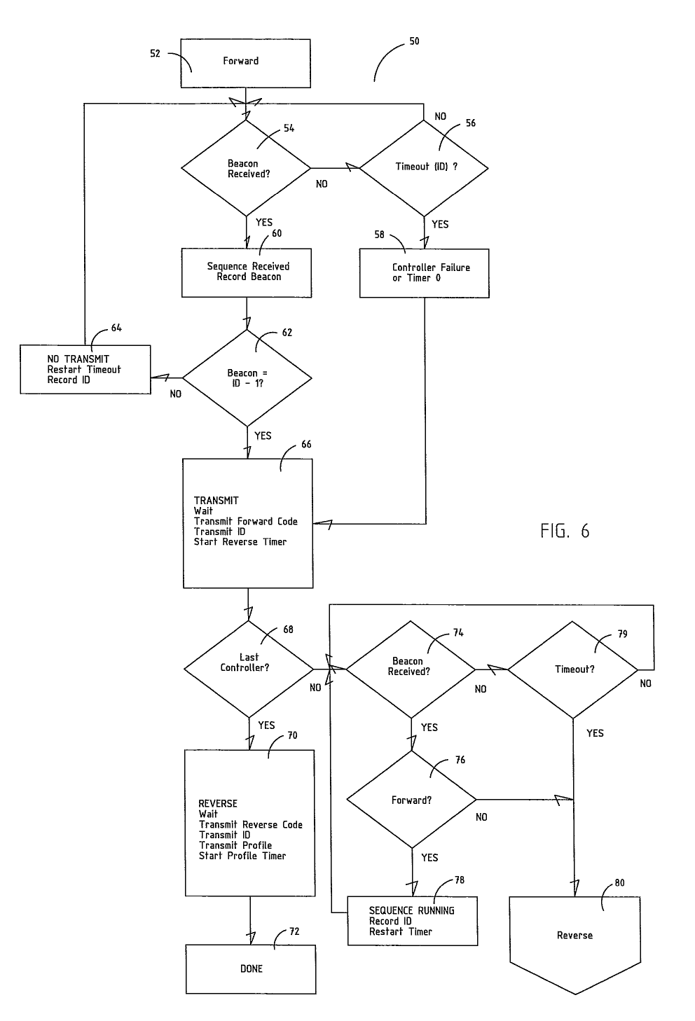

A computer algorithm 50 for operation of a global positioning receiver mounted on a vehicle is illustrated in FIG. 6. The algorithm 50 begins 52 by attempting to detect 54 a GPS signal. If a signal is not received, the computer checks 56 a clock for an ID timeout, that is for a maximum allowable period of time since the last successful receipt of a signal. If the timeout period has not expired, the receiver will continue to test 54 for a signal. Otherwise, the receiver will report 58 a failure, reset the timer and proceed to a transmit step 66. If a beacon is received 54, the computer of the receiver will record 60 the beacon signal. If the beacon signal is equal 62 to an expected location identification immediately preceding a location where a audio segment should be played (ID−1), The GPS receiver initiate a transmit sequence 66 by pausing for a period of time, then transmitting the sequence code of the GPS receiver and a location identification or ID. Any audio players responsive to the sequence code of the GPS receiver would then respond by playing an audio track associated with the ID or location code. If the beacon signal is not equal 62 to ID−1, no transmission would be made, and the timeout would be reset 64 so that the GPS receiver would continue checking 54 for an appropriate beacon.

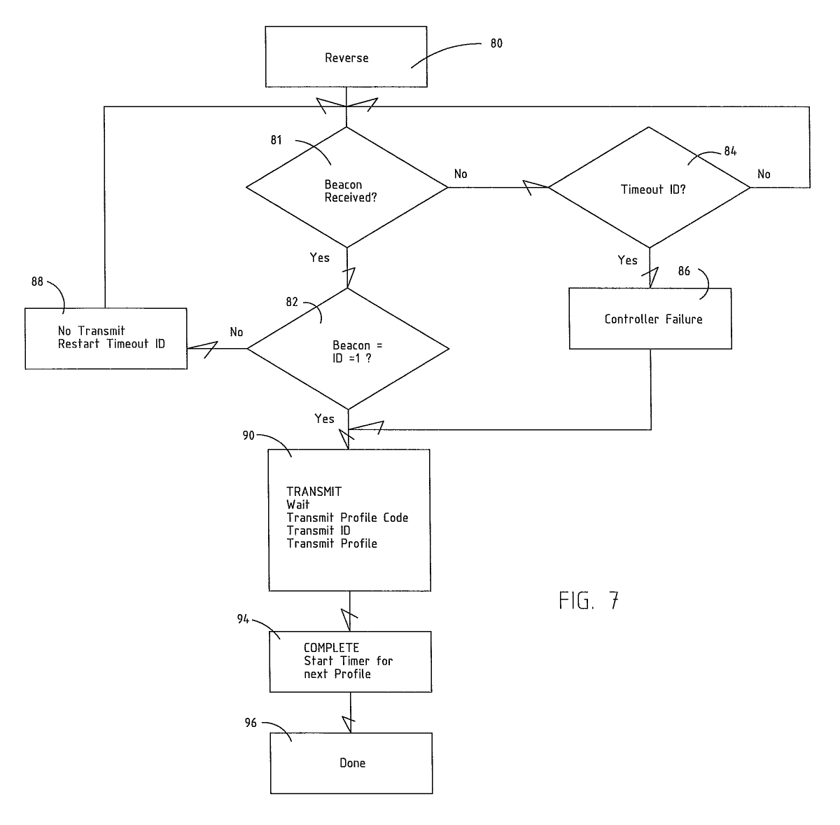

After transmitting 66, the GPS receiver checks 68 to see if the received beacon signal was from the last controller. If the last expected controller has been detected, the GPS receiver will wait a period of time, then transmit 70 a profile code, the location ID and a profile. The program will then end 72. If the last controller has not been detected 68, the GPS receiver again checks 74 for reception of a location beacon. If a beacon has not been received and a timeout 79 has occurred, the program shifts to check for reverse travel 80 (see FIG. 7). If the ID is for the expected forward location 76, it is assumed that the GPS receiver is within a zone where an identified audio segment should be played. The sequence is deemed to be running 78, and the location ID is recorded.

If a beacon has not been received 74 and timeout has occurred 79, the GPS receiver again checks 81 for a location beacon (see FIG. 7). If no signal is received within a timeout period 82, a controller failure is declared 84, and a transmission 90 is made. If a beacon is received 80 and the beacon ID has changed to the next expected location (ID+1), the GPS receiver transmits 90, after a selected pause, a profile code, the location ID and a profile. If the location has not changed 86, the computer of the GPS receiver resets 88 the timeout period and continues to scan for a location beacon, thereby waiting for a change of location to be detected.

After the transmission 90, the GPS receiver checks if the first controller has been detected. If the first controller has been detected, the sequence is complete, and a timer can be started 94 for the next profile 96.

Each of the audio players, which may be MP3 players, respond 100 to the signals transmitted by the GPS receivers as shown in FIG. 7. The audio player checks 102 for a transmission from a GPS receiver for a selected period of time 104, or timeout period. If a transmission is received, and the location ID has changed 106, the audio recorder logs 110 the new ID. If the location ID has not changed, the audio recorder will record 108 the profile of the GPS receiver sending the transmission. This information allows the audio player to play a track associated with the identified GPS receiver and location ID.

If no transmission is received during the timeout period, the audio player determines if the last expected location ID has been detected 112. If not, the audio recorder searches 114 for and plays an audio track associated with the identified location. Otherwise, the audio recorder stores 116 the profile for the last detected GPS receiver. The sequence repeats 118 as long as the system is in operation.

It will be apparent to those skilled in the art that various modifications and variations can be made to the structure and methodology of the present invention without departing from the scope or spirit of the invention. Rather, the invention is intended to cover modifications and variations provided they come within the scope of the following claims and their equivalents.

We claim:

1. An audio information system comprising,
At least one controller, said controller having
A global positioning system receiver, and
A radio frequency transmitter electrically coupled thereto and broadcasting an audio track identification based on a position sensed by the global positioning system receiver, and
At least one audio player, said audio player having
A radio frequency receiver, and
A set of audio tracks, playback of a selected audio track being enabled by receipt of an audio track identification from said controller.

2. The audio information system of claim 1 further comprising
A plurality of controllers, and wherein
Said audio player comprises means for identifying the closest controller and accepting the audio track identification from said closest controller.

3. The audio information system of claim 2 wherein each controller broadcasts a controller identification signal.

4. The audio information system of claim 3 further comprising means for assigning sequential identifiers to adjacent controllers.

5. The audio information system of claim 4 wherein each of said controllers has a broadcast area, and each broadcast area overlaps at least each adjacent broadcast area.

6. The audio information system of claim 5 wherein each controller is mounted on a transportation vehicle.

7. The audio information system of claim 6 wherein the transportation vehicle is a train.

8. The audio information system of claim 2 wherein each controller is mounted on a transportation vehicle.

9. The audio information system of claim 8 wherein the transportation vehicle is a train.

10. The audio information system of claim 1 wherein each controller is mounted on a transportation vehicle.

11. The audio information system of claim 10 wherein the transportation vehicle is a train.
